(19) United States
(12) Patent Application Publication
(10) Pub. No.: US 2021/0225559 A1
(43) Pub. Date: Jul. 22, 2021

(54) FOIL INDUCED HIGH FREQUENCY SKIN EFFECT IN STRANDED CENTER CONDUCTOR COPPER CABLE

(71) Applicant: Terrell Simpson, Round Rock, TX (US)

(72) Inventor: Terrell Simpson, Round Rock, TX (US)

(21) Appl. No.: 17/153,539

(22) Filed: Jan. 20, 2021

Related U.S. Application Data
(60) Provisional application No. 62/963,818, filed on Jan. 21, 2020.

(51) Int. Cl. H01B 11/10; H01B 11/18

(52) U.S. Cl. CPC H01B 11/1033; H01B 11/1869

(57) ABSTRACT

A cable apparatus is disclosed which can include at least one metal stranded center conductor, and a metal foil wrap that surrounds and wraps the at least one metal stranded center conductor. In addition, the cable apparatus can include an insulating layer that surrounds the metal foil wrap, and may include a shielding that surrounds and encapsulates the insulating layer. A jacket can surround the shielding. The cable apparatus can be used in coaxial, twin-coaxial, and twisted pairs wire arrangements.

### CROSS-REFERENCE TO PROVISIONAL APPLICATION

This patent application claims priority under 35 U.S.C. 119(e) to U.S. Provisional Patent Application Ser. No. 63/963,818 entitled “Rotary-Vane Mechanism for Engines and Compressors,” which was filed on Jan. 21, 2020, the disclosure of which is incorporated herein by reference in its entirety.

### TECHNICAL FIELD

Embodiments are related to the field of data communications and conductors and cabling used in the transmission of such data. Embodiments are also related to high speed conductors such as coaxial, twin-coaxial and twisted pairs wires.

### BACKGROUND

Conductors such as coaxial cable, semi-rigid coaxial, twin-coaxial cable and twisted pairs wires are used in high-speed data communications applications. For example, many high-speed applications employ copper based coaxial, twin-coaxial, semi-rigid coaxial and twisted pair wire for the transmission of video and/or data signals, especially above 1 Gbps data rates. Desktops, notebooks, servers, UAVs (Unmanned Aerial Vehicles) and any device containing computing and/or video components are all examples of applications that can benefit from such conductors. These types of devices typically rely on coaxial, micro-coaxial, semi-rigid and/or twisted pair wire to transmit high speed video or data signals.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved cable apparatus

It is another aspect of the disclosed embodiments to provide for a foil wrap cable apparatus that includes a metal foil wrap around a metal stranded center conductor wire construction.

It is still another aspect of the disclosed embodiments to provide for a foil wrap cable apparatus that can be used with coaxial, semi-rigid coaxial, twin-coaxial, and twisted pairs wire arrangements.

It is a further aspect of the disclosed embodiments to provide for a foil wrap cable apparatus for use with high-speed video and data communication applications and devices, such as computer servers, notebook computers, desktop computers, UAVs and so on.

The aforementioned aspects and other objectives and advantages can now be achieved as described herein. A cable apparatus is disclosed which can include at least one metal stranded center conductor, and a metal foil wrap that surrounds and wraps the at least one metal stranded center conductor. In addition, the cable apparatus can include an insulating layer that surrounds the metal foil wrap and a shielding that surrounds and encapsulates the insulating layer. A jacket can surround the shielding.

In some embodiments, the shielding can be implemented as a single spiral shielding, a braided shielding, a double shielding in a combination of spiral or braided wires and also in conjunction with a metalized film, and so on. The cable apparatus can be implemented in a coaxial wire arrangement, semi-rigid coaxial or twin wire arrangement, a twin-coaxial wire arrangement, or in a twisted pairs wire arrangement.

The use of a metal foil wrap around a metal stranded center conductor wire construction can allow a stranded wire performance to approach the performance of an equivalently constructed solid center conductor wire, while maintaining the flexibility of stranded wire. It is noted that the use of foil wraps to provide for skin effect in stranded center conductor wire is showing in models that the electronics in fact can migrate to both sides of the foil wrap thus resulting in a slightly better performance than that of solid center conductors. More research may be needed to conclude that this will be the case in the real world, but this is certainly a significant observation.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a graph depicting data related to a single gauge coaxial wire apparatus;

FIG. 2 illustrates a graph depicting data related to a twin-coaxial wire apparatus; and

FIG. 3 illustrates a cut-away perspective view of a foil wrap cable apparatus, in accordance with an embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. For example, preferred and alternative embodiments are disclosed herein.

Additionally, like numbers refer to identical, like or similar elements throughout, although such numbers may be referenced in the context of different embodiments. As used herein, the term “and/or” includes any and all combinations of one or more of the associated listed items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The disclosed embodiments relate to a foil wrap cable apparatus that can provide high speed performance for copper based cabling by using a foil wrap around a stranded center conductor of cable or cabling whether discrete, coaxial, twin-coaxial, semi-rigid and/or discrete twisted pairs. Such a foil wrap cable apparatus can be validated based on a simulation model of stranded (e.g., single gauge) coaxial wire.

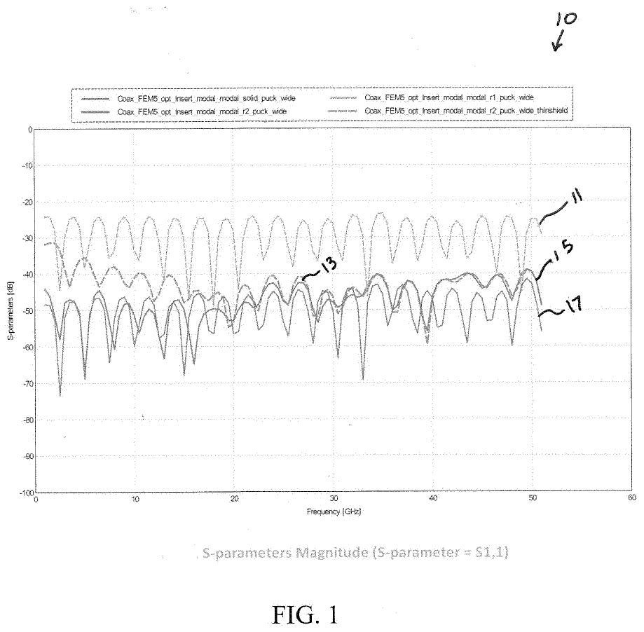

FIG. 1 illustrates a graph 10 depicting data related to a single gauge coaxial wire apparatus. Graph 10 is a return loss chart for a single gauge coaxial wire, and shows a dotted green line 11, which represents a stranded coaxial wire without foil having a higher loss rate than the dark blue solid line 17 representing a solid center conductor coaxial wire. With these two models as a baseline, we note that the red line 15 and the dotted light blue line 13 represent a foil wrapped stranded center conductor coaxial wire that outperforms a standard stranded center conductor wire represented by the dotted green line 11.

The light blue line 17 represents a foil wrap so thin we would expect at low frequencies that the skin depth effect would theoretically need to be thicker, and that the behavior would approach that of a non-wrapped stranded center wire (and certainly, in this case it did just that). Note that some embodiments can employ twin-coaxial, semi-rigid and twisted pair discrete wires to further advance our understanding and test additional hypotheses, but early results are very similar to what has been with single gauge coaxial wire models.

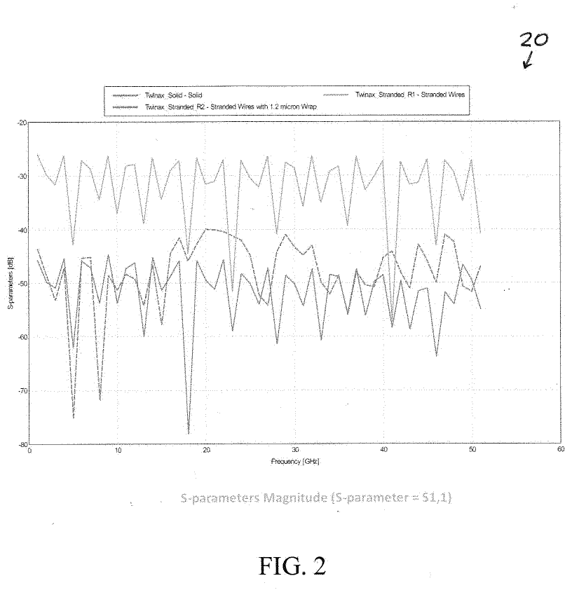

FIG. 2 illustrates a graph 20 depicting data related to a twin-coaxial wire apparatus. Graph 10 in FIG. 1 charts data depicting the results of a single gauge coaxial wire. Graph 20 in FIG. 2 plots data demonstrating the results of a study of a twin-coaxial wire, which yielded very similar results to that of graph 10 of FIG. 1.

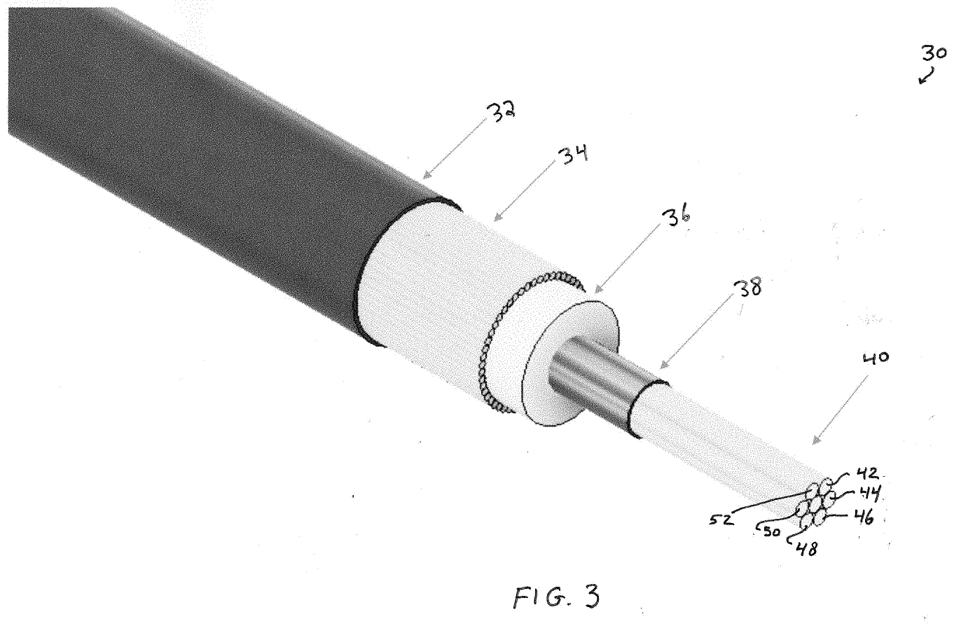

FIG. 3 illustrates a cut-away perspective view of a foil wrap cable apparatus 30, in accordance with an embodiment. The foil wrap cable apparatus 30 shown in FIG. 3 includes a group 40 of one or more stranded center conductors 42, 44, 46, 48, 50, and 52 that are surrounded by a metal foil wrap 38 (which can also be referred to as a “foil wrap” or “foil wrapping”). The metal foil wrap 38 can be surrounded by an insulating layer 36, which in turn can be encapsulated by a shielding 34. The insulating layer 36 can be configured as a tubular insulating layer. In turn, the shielding can be surrounded by a jacket 32. The shielding 34 can be implemented in some embodiments as a tubular conducting shield and can be implemented as a braided shield. The foil wrap cable apparatus 30 can be implemented in the context of coaxial, semi-rigid, twin-coaxial or twisted pairs applications and components.

While there are a number of additional hypotheses that may still need investigating, an important feature of the foil wrap cable apparatus 30 is the use of the metal foil wrap 38 around the metal stranded center conductor wire construction (i.e., the group 40 of stranded center conductors 42, 44, 46, 48, 50, and 52) to enable stranded wire performance to approach the performance of an equivalently constructed solid center conductor wire while maintaining the flexibility of a stranded wire. This approach can use classical mathematical models to calculate a skin depth effect to size the foil thickness used to wrap the strands with sufficient depth to support the skin effect for a targeted frequency range (e.g., 5 GHz to 40 GHz or 0.317 to 0.89 microns).

Some of the advantages of the foil wrap cable apparatus 30 can include, for example, a low cost, low conductivity stranded core that can be used with a highly conductive foil wrap (e.g., See Appendix A—the chart with nichrome strands vs silver strands both with silver foil wrap—slides 5 and 6) with good results on return and insertion loss. Also, additional gains may be achieved with foil wraps in a twin-coaxial wire arrangement due to coupling effects. Another advantage of the foil wrap cable apparatus 30 is that common manufacturing techniques can be used for low loss cable designs, which can be enhanced by foil wrapping and/or different material selections. An additional advantage of the foil wrap cable apparatus 30 is that the apparatus 30 can provide for a low loss shielding, particularly braided shieldings that are cold pressed for applications to reduce the wire OD while further improving performance and maintaining the flexibility of stranded wire using foil wraps. Yet another advantage of the foil wrap cable apparatus 30 is that wires with foil wrapped center conductors may outperform better than normal stranded wires and compare to wires with solid center conductors of larger gauges and at different frequencies (e.g., See Appendix A chart 6 showing an electron density model).

The use of a foil wrapping around a stranded center conductor wire can enable skin depth effects such as high frequency data transmission while at the same time preserving the flexibility of stranded wire performance. This is a significant breakthrough as data rates will likely continue increasing well beyond 10 Gbps. The increased return loss (RL) and insertion loss (IL) performance among other signal integrity attributes may have huge implications in reducing wire bundle sizes for cable routing in devices as well as lengths of cables while improving performance to match closely with that of a solid center conductor constructed wire.

A problem that the foil wrap cable apparatus 30 can solve is the flexibility versus performance equation: namely, as cable lengths increase so does the attenuation (loss: RL & IL). Because we are seeing a −20 dB return loss improvement in the foil wrapped stranded wires applications and as much as −3 dB insertion loss improvement at 1 meter through 70 GHz, will can maintain or even gain flexibility where it was not previously possible and at the same time obtain better performance. There are a number of server application and hinge-up applications such as in computer notebooks that may be able to deliver faster data and/or high video quality as a result of bandwidth performance.

The foil wrap cable apparatus 30 can be implemented in highspeed applications that employ copper based coaxial, twin-coaxial, semi-rigid and/or twisted pair wire for the transmission of video and/or data signals, especially above 1 Gbps data rates. Desktops, notebooks, servers and any device containing computing and/or video components are all applications that can benefit from the foil wrap cable apparatus 30. Such applications can rely on coaxial, micro-coaxial, semi-rigid and/or twisted pair wire to transmit high speed video or data signals.

OEM's such as Dell, Intel, Apple among many others are all potential beneficiaries of the disclosed embodiments. High speed cabling is frequently used in most if not all of the products from such companies. Further, the Tier 1 cabling suppliers such as Sumitomo and Hitachi who produce and sell bulk cable as well as Tier 1 Cable Assembly Suppliers like TE Connectivity, Foxconn, 3M and Amphenol who produce their own high speed bulk cable are also potential beneficiaries whose products performance can be improved with the disclosed embodiments.

Based on the foregoing, it can be appreciated that a number of embodiments are disclosed herein. For example, in an embodiment, a cable apparatus can include at least one metal stranded center conductor, and a metal foil wrap that surrounds and wraps the at least one metal stranded center conductor. In some embodiments, the cable apparatus can further include an insulating layer that surrounds the metal foil wrap, and a shielding that surrounds and encapsulates the insulating layer. In still another embodiment of the cable apparatus, the aforementioned shield can comprise a spiral shielding or a braided shielding.

In some embodiments of the cable apparatus, the aforementioned shielding can include a metalized secondary shielding.

In another embodiment, the at least one metal stranded center conductor and the metal foil can be implemented in a coaxial wire arrangement. In still another embodiment, the at least one metal stranded center conductor and the metal foil can be implemented in a twin-coaxial wire arrangement. In yet another embodiment, the at least one metal stranded center conductor and the metal foil can be implemented in a twisted pairs wire arrangement. In some embodiments, the at least one metal stranded center conductor and the metal foil can be implemented in a semi-rigid wire arrangement.

In another embodiment, an insulating layer can be provided, which surrounds the metal foil wrap; and can be implemented in a twisted arrangement for impedance control. In yet another embodiment, the at least one metal stranded center conductor and the metal foil can be implemented in a multi-twisted pair arrangement with or without shielded pairs. (e.g., Cat5 or Cat6, etc.)

It will be appreciated that variations of the above-disclosed and other features and functions, or alternatives thereof, may be desirably combined into many other different systems or applications. It will also be appreciated various presently unforeseen or unanticipated alternatives, modifications, variations or improvements therein may be subsequently made by those skilled in the art, which are also intended to be encompassed by the following claims.

What is claimed is:

1. A cable apparatus, comprising:
at least one metal stranded center conductor; and
a metal foil wrap that surrounds and wraps the at least one metal stranded center conductor.

2. The cable apparatus of claim 1 further comprising:
an insulating layer that surrounds the metal foil wrap; and
a shielding that surrounds and encapsulates the insulating layer.

3. The cable apparatus of claim 2 wherein said shielding comprises a spiral or braided shielding.

4. The cable apparatus of claim 2 wherein the shielding further comprises a metalized secondary shielding.

5. The cable apparatus of claim 1 wherein the at least one metal stranded center conductor and the metal foil are implemented in a coaxial wire arrangement.

6. The cable apparatus of claim 1 wherein the at least one metal stranded center conductor and the metal foil are implemented in a twin-coaxial wire arrangement.

7. The cable apparatus of claim 1 wherein the at least one metal stranded center conductor and the metal foil are implemented in a twisted pairs wire arrangement.

8. The cable of apparatus of claim 1 wherein the at least one metal stranded center conductor and the metal foil are implemented in a semi-rigid wire arrangement.

9. The cable apparatus of claim 1 further comprising:
an insulating layer that surrounds the metal foil wrap

10. The cable apparatus of claim 1 wherein the insulating layer and the metal foil wrap are implemented in a twisted arrangement for impedance control.

11. The cable of apparatus of claim 9 wherein the at least one metal stranded center conductor and the metal foil are implemented in a multi-twisted pair arrangement with or without shielded pairs.

12. A cable apparatus, comprising:
at least one metal stranded center conductor;
a metal foil wrap that surrounds and wraps the at least one metal stranded center conductor;
an insulating layer that surrounds the metal foil wrap; and
a shielding that surrounds and encapsulates the insulating layer.

13. The cable apparatus of claim 12 wherein said shielding comprises a spiral or braided shielding.

14. The cable apparatus of claim 12 wherein the shielding further comprises a metalized secondary shielding.

15. The cable apparatus of claim 12 wherein the at least one metal stranded center conductor and the metal foil are implemented in a coaxial wire arrangement.

16. The cable apparatus of claim 12 wherein the at least one metal stranded center conductor and the metal foil are implemented in a twin-coaxial wire arrangement.

17. The cable apparatus of claim 12 wherein the at least one metal stranded center conductor and the metal foil are implemented in a twisted pairs wire arrangement.

18. The cable of apparatus of claim 12 wherein the at least one metal stranded center conductor and the metal foil are implemented in a semi-rigid wire arrangement.

19. The cable apparatus of claim 12 further comprising
an insulating layer that surrounds the metal foil wrap,
wherein the insulating layer and the metal foil wrap are implemented in a twisted arrangement for impedance control, and
wherein the at least one metal stranded center conductor and the metal foil are implemented in a multi-twisted pair arrangement with or without shielded pairs.
